(19) United States
(12) Patent Application Publication
(10) Pub. No.: US 2024/0009490 A1
(43) Pub. Date: Jan. 11, 2024

(54) RESPIRATOR

(71) Applicant: MANCHESTER UNIVERSITY NHS FOUNDATION TRUST, Manchester, Greater Manchester (GB)

(72) Inventors: Brendan McGRATH, Manchester, Greater Manchester (GB); Andrew SPRAGG, Manchester, Greater Manchester (GB); Andrew FORBES, Manchester, Greater Manchester (GB); Patrick HALL, Manchester, Grekater Manchester (GB)

(73) Assignee: MANCHESTER UNIVERSITY NHS FOUNDATION TRUST, Manchester, Greater Manchester (GB)

(21) Appl. No.: 18/042,305

(22) PCT Filed: Aug. 19, 2021
(86) PCT No.: PCT/GB2021/052147

§ 371 Date: Feb. 21, 2023

(30) Foreign Application Priority Data
Aug. 21, 2020 (GB) 2013104.1

(51) Int. Cl. A62B 18/00; A62B 23/02

(52) U.S. Cl. CPC A62B 18/006; A62B 23/02

(57) ABSTRACT

A powered air purifying respirator (PARR) has a yoke and a pump. The yoke defines an air inlet and an air outlet fluidly connected via an air flow passage. The pump is disposed within an interior of the yoke and is configured to pump air from the air inlet to the air outlet via the air flow passage. The yoke is shaped to fit around the user's neck and be supported by the user's shoulders. A hood for a PARR has a head portion configured to receive a user's head, and a one-way exhaust valve configured to vent air from an internal environment of the hood to an environment external to the hood. The hood is configured to receive a yoke of the PARR.

### CROSS-REFERENCE TO RELATED APPLICATIONS

This application is a national stage application, filed under 35 U.S.C. § 371, of International Patent Application No. PCT/GB2021/052147 filed on Aug. 19, 2021, which claims priority to Great Britain Application No. 2013104.1 filed on Aug. 21, 2020, the contents of all of which are entirely incorporated by reference herein.

### BACKGROUND OF THE DISCLOSURE

### 1. Field of the Disclosure

The present invention relates to a powered air purifying respirator, a hood for a powered air purifying respirator, a method of donning a powered air purifying respirator and a method of doffing a powered air purifying respirator. In particular, the present invention relates to a powered air purifying respirator that is collar-mounted, such that it is worn around the user's neck.

### 2. Description of Related Art

A powered air purifying respirator (PAPR) is a respiration device worn by a user to prevent harmful airborne substances from being inhaled. Such harmful substances can include particulates such as dust, smoke or the like, or pathogens such as bacteria, viruses, or other microorganisms. Some known PAPRs comprise a filter, a pump, a flexible conduit, a face mask and a power supply such as a battery. The pump, the battery and the filter are typically provided in a single unit separate to the face mask and are fluidly connected to the face mask via the flexible conduit. The pump and filter unit is typically attached to the user via a belt or clip, and is worn on the user's body. The pump acts to draw air from the environment through the filter, whereupon the filter removes any harmful substances carried by the air. Once the air has been filtered, it is delivered to the face mask via the flexible conduit. The face mask is typically attached to the user's head using a number of adjustable straps, and normally covers the entirety of the user's face from below the jaw to above the eyes. Often, a release valve is provided so that air exhaled by the user is vented from the face mask.

PAPRs have previously been considered for use in medical applications, especially for the treatment of patients having highly infectious diseases which may be transmitted by aerosols generated by coughing and sneezing. However, known PAPRs are cumbersome and can be difficult to remove after use. There is a risk that the user may accidentally come into contact with harmful pathogens that have settled on the outer surfaces of the PAPR during removal and that this could infect the user. Furthermore, before the PAPR can be used again, all external components of the PAPR must be sterilised to remove any harmful pathogens.

It has previously been proposed to provide a PAPR having a disposable face covering in place of a mask. One such PAPR comprises a headband to which the pump and filter are mounted so that the pump and filter are positioned directly above the user's head. The disposable face covering is a clear plastic bag which comprises a hole through which an inlet to the pump is received. The face covering is draped around the user's head and gathered around the user's neck so that the entire head of the user is encapsulated by the face covering. However, because the weight of the pump and the filter is supported entirely by the headband, the headband is uncomfortable for the user. Furthermore, supporting the pump and filter above the user's head makes the PAPR “top-heavy” and liable to fall off the user if the user's head is tilted too far.

It is therefore an object of the present invention to provide an improved or alternative powered air purifying respirator, a hood for a powered air purifying respirator and methods of donning and doffing a powered air purifying respirator which may obviate or mitigate one or more disadvantages of the prior art, whether identified herein or elsewhere.

### SUMMARY OF THE DISCLOSURE

According to a first aspect of the invention, there is provided a powered air purifying respirator (PAPR) comprising: a yoke defining an air inlet and an air outlet fluidly connected via an air flow passage; and a pump disposed within an interior of the yoke and configured to pump air from the air inlet to the air outlet via the air flow passage; wherein the yoke is shaped to fit around the user's neck and be supported by the user's shoulders. That is to say, the yoke is worn over the user's shoulders such that the weight of the yoke and any components contained within the yoke is supported by the user's shoulders. Because the yoke is worn over the shoulders, the PAPR is more comfortable to wear than a head-mounted PAPR. Furthermore, because the yoke is shaped to fit around the user's neck, the yoke is not disturbed when the user's head is tilted. This is particularly beneficial for use in medical applications, such as surgery, so that the mobility of the user's head is not impeded. Additionally, because the air flow passage is contained within the yoke, no external tube is necessary for connecting a pump and filter unit to a face mask as required in prior art PAPRs. As such, the PAPR of the present invention is less bulky and therefore easier to don and doff. Furthermore, the absence of an external tube simplifies the overall packaging of the PAPR and means that there are fewer surfaces to clean after use. The term “pump” encompasses substantially any suitable means for generating positive air flow through the air flow passage. This may include, for example, fans, blowers, positive-displacement pumps, peristaltic pumps, centrifugal pumps or the like.

The yoke may define a pair of shoulder rests configured to rest upon the user's shoulders. The term “shoulder rest” encompasses a portion of an underside of the yoke that is configured to engage the user's shoulders and may in particular be scalloped, curved, contoured or otherwise shaped to mirror the geometry of a generalised shoulder. The yoke may be generally ring-shaped and may define a central aperture configured to receive the user's head. Put another way, the yoke may be generally collar-shaped so that it fits around the user's neck in the manner of a collar.

The yoke may comprise a front portion and a rear portion relative to the user's head. The air inlet may be defined by the rear portion of the yoke. The air outlet may be defined by the front portion of the yoke. In the treatment of patients having a highly contagious airborne disease, it will be appreciated that the atmosphere surrounding the patient is likely to contain a higher concentration of potentially harmful pathogens. When the air intake is defined by the rear portion of the yoke, this places the air intake on the far side of the user relative to a patient where the atmosphere is less likely to contain harmful pathogens or where the concentration of any harmful pathogens in the atmosphere is likely to be lower. As such, this minimises the pathogen burden of the intake air and reduces the chance that harmful pathogens could make their way past the filter.

The rear portion of the yoke may define a rearwardly facing surface in relation to the user's head. The air inlet may be positioned on the rearwardly facing surface.

The front portion of the yoke may define an upper surface. The air outlet may be positioned on the upper surface of the yoke such that during use air exiting the yoke via the air outlet is directed towards the user's face. When the air outlet is positioned on the upper surface of the front portion of the yoke, this ensures that clean air is delivered close to the user's mouth and nose so that the clean air can be inhaled efficiently. Furthermore, because the clean air is delivered close to the user's mouth and nose, the clean air counteracts the build-up of water vapour on the inside of a hood used with the yoke (discussed below) caused by the user's breath. Additionally, delivering the filtered air in front of the user's face keeps the user cool and minimises the formation of higher concentrations of Carbon Dioxide (CO2) in pockets close to the user's nose and mouth.

The PAPR may further comprise a filter in gas flow communication with the air inlet. The filter may be removable. The filter may remove harmful substances from the air, so that clean air is delivered to the user. The filter may be connected to the air inlet on an exterior of the yoke. That is to say, the filter may be external to the yoke. It will be appreciated that the filter is a consumable element that may require periodic replacement, however a single filter may be used multiple time without the need for disposal. When the filter is external to the yoke, this enables the filter to be replaced easily.

The yoke may comprise an outwardly extending spigot defining the air inlet. The spigot may be configured for engagement with a filter.

The PAPR may further comprise a hood configured to receive the yoke and the user's head therein. When a hood is provided, during use the yoke is received within the hood and the hood and the yoke are placed over the user's head. The hood forms a barrier around the user's head separating an environment inside the hood containing the user's head from an environment outside the hood. The environment inside the hood is supplied with clean air from the filter via the air outlet of the yoke. Accordingly, the hood separates clean, pathogen-filtered, air inside the hood from unclean, pathogen-exposed, air outside of the hood.

Additionally, because the yoke is received within the hood, the hood also acts as a barrier protecting the yoke from exposure to pathogens. Accordingly, the yoke is much less likely to come into contact with harmful pathogens, and therefore the risk that a user could become infected by contact with the yoke in a subsequent usage of the PAPR is minimised. However, in most cases the yoke will still be cleaned with a sterilising solution (e.g. alcohol, detergent or chlorhexidine-based wipes) between each use.

Furthermore, when the hood is a separate component of the PAPR to the yoke, the hood can be easily uncoupled from the yoke and disposed of. As such, any pathogens that have become attached to the exterior of the hood, for example pathogens contained in airborne water droplets that have landed on the exterior of the hood, can be disposed of simultaneously with the hood.

During use the hood may surround an outer periphery of the yoke. The term “outer periphery of the yoke” encompasses a radially outer perimeter of the yoke relative to the user's head and/or neck. In particular, the “outer periphery of the yoke” may be the outermost parts of the yoke. When the hood surrounds the outer periphery of the yoke, the yoke acts to space the hood apart from the user's head and in particular spaces the hood away from the front of the user's face. As such, the user's face does not come into contact with the hood when the PAPR is being worn. Consequently, the PAPR is more comfortable to wear.

The hood may comprise an aperture configured to receive a spigot of the yoke therethrough. The PAPR may further comprise a filter, and the hood may comprise an aperture configured to permit gas flow communication between the filter and an environment external to the hood. The aperture may comprise a circumferentially extending lip configured to engage the filter to couple the hood to the filter on an interior side of the hood. The hood may comprise a split or a line of perforations extending radially outwards from the aperture. When the hood comprises a line of perforations, the perforations may be torn to create a split. The split provides an opening in the hood to enable the filter to be received therethrough, such that the filter does not need to be removed from the yoke in order to remove the hood. The aperture may comprise a side opening configured to permit the air inlet and/or spigot to enter the aperture from the side. The split or line of perforations may extend from the aperture to bottom of a poncho of the hood.

The hood may comprise a head portion configured to be positioned over the user's head. The hood may comprise a poncho configured to be tucked under the yoke between the yoke and the user's body. The head portion may be generally cylindrical, however in alternative embodiments non-cylindrical shapes may be used to define the head portion. The hood may comprise a gathering mechanism configured to gather the poncho around the user's neck. The gathering mechanism may enable the hood to be gathered around the user's neck so as to form an approximate seal against the user's neck. The gathering mechanism may comprise a draw string, a belt, coupling elements or the like.

The head portion may comprise a transparent portion. When the head portion of the hood comprises a transparent portion, the transparent portion can be aligned with the user's eyes so that the user is able to see through the hood. The transparent portion may be made, for example, from a flexible clear plastic sheet. The head portion of the hood may comprise some or all of the transparent portion. The head portion may be made from a gas-impermeable material.

The poncho may comprise a flexible impermeable membrane. When the poncho comprises a flexible impermeable membrane, the poncho is flexible and easier to gather than the transparent portion, so as to assist the user in tucking the poncho under the yoke. The membrane may be thinner and softer than the transparent portion, so as to make the hood more comfortable to wear for the user.

The hood may comprise a one-way exhaust valve configured to vent air from an interior side of the hood to an exterior side of the hood. The term “one-way exhaust valve” encompasses a non-return valve or other suitable means which is able to vent air passing from the inside of the hood to the outside of the hood whilst simultaneously preventing air (and any pathogens carried by the air) from passing from the outside of the hood to the inside of the hood. The one-way exhaust valve may be positioned at the top of the hood.

When the exhaust valve is positioned on the top portion of the hood this ensures that the air vented from the interior of the hood is directed away from the patient, thus reducing the chance that the patient could be exposed to pathogens originating from the user's breath. This is particularly useful when the PAPR is used in a clinical setting.

The yoke may comprise a first engagement portion and wherein the hood comprise a second engagement portion configured to engage the first engagement portion so as to attach the hood to the yoke. The term “engagement portion” encompasses any means forming part of the yoke and/or the hood suitable for engagement with a corresponding means of the other of the yoke and/or the hood.

The first engagement portion may comprise a protrusion and the second engagement portion may comprise a recess configured to receive the protrusion. When the protrusion is received by the recess, frictional engagement between the recess and the protrusion couples the hood to the yoke so that the hood is securely held in position. In alternative embodiments, the first engagement portion may comprise a recess and the second engagement portion may comprise a protrusion configured for receipt by the recess.

The hood may comprise a gripping portion configured to engage an apron. The apron may be a disposable apron worn over the user's front to protect a patient from the user's clothing, for example in a surgical procedure. Because the tab is provided on the exterior side of the hood, the gripping portion can be accessed by the user without the need to remove the hood and therefore aprons can be attached to and removed from the PAPR without the need to doff the PAPR. The use of different aprons for each patient is a key infection control method, and therefore the ability to attach an apron to the yoke of the PAPR without doffing saves time between the treatment of different patients. Furthermore, the gripping portion does not require the user to lift the apron over the user's head and therefore avoids any accidental contact between contaminated and non-contaminated parts of the user's body.

The gripping portion may comprise an aperture configured to receive and frictionally engage a portion of the apron. The aperture may further comprise one or more inwardly extending cantilevered arms configured to frictionally engage the portion of the apron. The cantilevered arms increase the surface area available for frictional engagement to make the connection between the apron and the gripping portion more secure.

The hood may comprise an outwardly extending tab defining the gripping portion. When the tab extends outwardly, it is easier to manipulate by the user ensuring that aprons can be attached and removed with ease.

The PAPR may further comprise a flowrate meter configured to measure the flowrate of air passing through the air flow passage. When a flowrate meter is used, the flowrate meter monitors the airflow into the interior of the hood. As such, the flowrate meter can be used to detect the presence of blockages, restrictions, malfunction of the pump, power failure, reduced battery capacity or the like that would impede the delivery of fresh air into the interior of the hood.

The flowrate meter may comprise a baffle disposed within the air flow passage, the baffle being configured to move in response to incident air flowing through the air flow passage. The flowrate meter may comprise a spring configured to urge the baffle towards a position indicative of low flow through the air flow passage.

The flowrate meter may comprise an indicator configured to display an indication of the flowrate of the air passing through the air flow passage to a user. The use of an indicator provides visual feedback to the user to confirm whether or not a sufficient volume of air is being drawn into the hood, and to thereby notify the user if there is a problem in the delivery of fresh air. For example, the flowrate indicator may comprise a portion of a first colour, for example red, to indicate that the flow is unacceptably low, and a portion of a second colour, for example green, to indicate that the flow is at an acceptable level. In some embodiments, the indicator may comprise a portion of a third colour to indicate that the filter has not been attached such that the flowrate is abnormally high. The indicator may be positioned at a front portion of the yoke. When the flowrate indicator is positioned at a front portion of the yoke, the flowrate indicator can be easily seen by the user.

The PAPR may further comprise a one-way valve positioned downstream of the flowrate meter, the one-way valve being configured to permit flow from the flowrate meter to the outlet and being configured to prevent flow from the air flow outlet to the flowrate meter. When the PAPR comprises a one-way valve, the one-way valve protects the flowrate meter from backflow through the air flow passage when the user sneezes or coughs, and provides protection for the flowrate meter when the yoke is being cleaned. Additionally, in the event that the pump fails or power to the pump is lost, the one-way valve will permit flow through the airflow passage into the interior of the hood whilst maintaining the pressure of the air within the hood. Because the pressure within the hood is maintained, exhaled air will be vented from the hood using the one-way exhaust valve, whilst fresh air will be drawn by the user's breath through the one-way valve.

According to a second aspect of the invention there is provided a hood for a powered air purifying respirator, the hood comprising: a head portion configured to receive a user's head, and a one-way exhaust valve configured to vent air from an internal environment of the hood to an environment external to the hood; wherein the hood is configured to receive a yoke of a powered air purifying respirator. The powered air purifying respirator may, in particular, be a powered air purifying respirator according to the first aspect of the invention.

The hood may further comprise an engagement portion configured engage a corresponding formation of the yoke of the powered air purifying respirator so as to attach the hood to the yoke. The hood may further comprise a poncho configured to be tucked underneath the yoke of the powered air purifying respirator between the yoke and the user's body. The hood may further comprise a gathering mechanism configured to gather the poncho around the user's neck.

According to a third aspect of the invention there is provided a method of donning a powered air purifying respirator, the powered air purifying respirator comprising: a yoke defining an air inlet and an air outlet fluidly connected via an air flow passage, the yoke being shaped to fit around the user's neck and to be supported by the user's shoulders; a pump disposed within an interior of the yoke and configured to pump air from the air inlet to the air outlet via the air flow passage; and a hood configured to receive the yoke and the user's head therein; wherein the method comprises: receiving the yoke within an interior of the hood; placing the yoke around the user's head such that the user's head is received within the interior of the hood; and supporting the yoke on the user's shoulders. When the yoke is supported on the user's shoulders it will be appreciated that the entire weight of the yoke and the hood is carried by the user's shoulders. As such, no headband, face straps or other means are required.

The hood may comprise a head portion and a poncho, and the method may further comprise: receiving the user's head in the head portion gathering the poncho around the user's neck using a gathering mechanism; and tucking the poncho underneath the yoke so that the poncho is positioned between the yoke and the user's body. Once the yoke is in position with the yoke gathered around the user's neck, the user may then don a medical gown. A portion of the medical gown may be received within the tucked part of the poncho between the yoke and the user's body. That is to say, a portion of the poncho may rest on top of the medical gown, whilst a portion of the poncho lies beneath the medical gown.

The yoke may comprise a first engagement portion and the hood may comprise a second engagement portion; and the method may further comprise engaging the second engagement portion with the first engagement portion to attach the hood to the yoke. The hood may further comprise a gripping portion and the method may further comprise attaching an apron to the hood using the gripping portion. The method may comprise attaching a filter to an air inlet of the yoke.

According to a fourth aspect of the invention there is provided a method of doffing a powered air purifying respirator, the powered air purifying respirator comprising: a yoke defining an air inlet and an air outlet fluidly connected via an air flow passage, the yoke being shaped to fit around the user's neck and being supported by the user's shoulders; a pump disposed within an interior of the yoke and configured to pump air from the air inlet to the air outlet via the air flow passage; and a hood defining an interior within which the yoke and the user's head are received; wherein the method comprises: lifting the yoke and the hood away from the user's head such that an exterior of the hood does not contact the user's head. In some embodiments, the hood may be lifted away from the user before the yoke. In other embodiments, the yoke and the hood may be lifted away from the user's head simultaneously. The method may further comprise folding the exterior side of the hood in on itself such that only the interior side of the hood is exposed.

The hood may comprise a head portion and a poncho, and wherein the method may further comprise: releasing a gathering mechanism to ungather the poncho from the user's neck; untucking the poncho from underneath the yoke; and removing the user's head from the head portion. The yoke may comprise a first engagement portion and the hood may comprise a second engagement portion engaged with the first formation; and the method may further comprise disengaging the second engagement portion from the first engagement portion to detach the hood from the yoke. The hood may further comprise a gripping portion and the method may further comprise detaching an apron from the gripping portion. The method may further comprise detaching a filter from an air inlet of the yoke.

The optional features of any of the aspects of the invention may be applied to the features of any of the other aspects of the invention. For example, any of the features of the PAPR of the first aspect of the invention and/or the hood of the second aspect of the invention may be applied to the methods of the third and fourth aspects of the invention. Furthermore, any of the features of the hood of the first aspect of the invention may be applied to the hood of the second aspect of the invention and vice versa.

### BRIEF DESCRIPTION OF THE DRAWINGS

A detailed description of the invention will now be provided with reference to the accompanying drawings, in which:

FIG. 1 is a perspective view of a powered air purifying respirator (PAPR) according to the present invention;

FIG. 2 is a perspective front view of a yoke of the PAPR;

FIG. 3 is a perspective rear view of the yoke of the PAPR;

FIG. 4 is a top plan view of the yoke of the PAPR;

FIG. 5 is a bottom plan view of the yoke of the PAPR;

FIG. 6 is a schematic cross-sectional view of the yoke of the PAPR;

FIG. 7 is a perspective assembled perspective view of a flowmeter of the PAPR;

FIG. 8 is an exploded perspective view of the flowmeter of the PAPR; and

FIG. 9 is a front plan view of a hood of the PAPR.

### DETAILED DESCRIPTION OF THE DISCLOSURE

### Powered Air Purifying Respirator

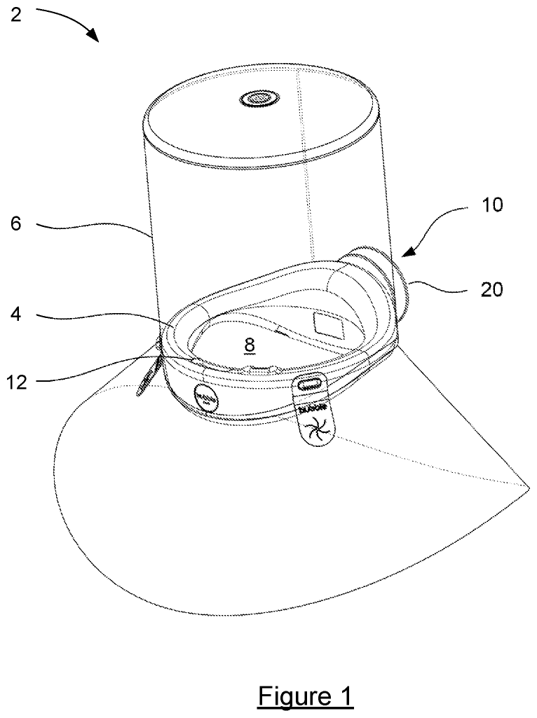

FIG. 1 shows a perspective view of a powered air purifying respirator (PAPR) 2 in accordance with the present invention. The PAPR 2 functions to remove harmful pathogens from atmospheric air before such air is inhaled by the user to protect the user from any disease transmitted by the pathogens. The PAPR 2 is suitable for use by a user working in the treatment of patients having highly contagious diseases transmitted by airborne pathogens. The user may be, for example, a medical professional, clinical support worker or the like. The above notwithstanding, the PAPR 2 may alternatively be used in generally any environment in which the atmosphere contains harmful substances that require removal from the atmospheric air before being inhaled by the user.

The PAPR 2 comprises a yoke 4 and a hood 6. The yoke 4 is generally ring-shaped and defines a central aperture 8 configured to receive a user's head. The yoke 4 is shaped to fit around the user's neck so that it is supported by the user's shoulders. Put another way, the yoke 4 is generally collar-shaped and fits around the user's neck in the manner of a collar. The hood 6 is large enough to fit around an outer periphery of the yoke 4 so as to contain both the user's head and the yoke 4 within the interior of the hood 6.

### Yoke

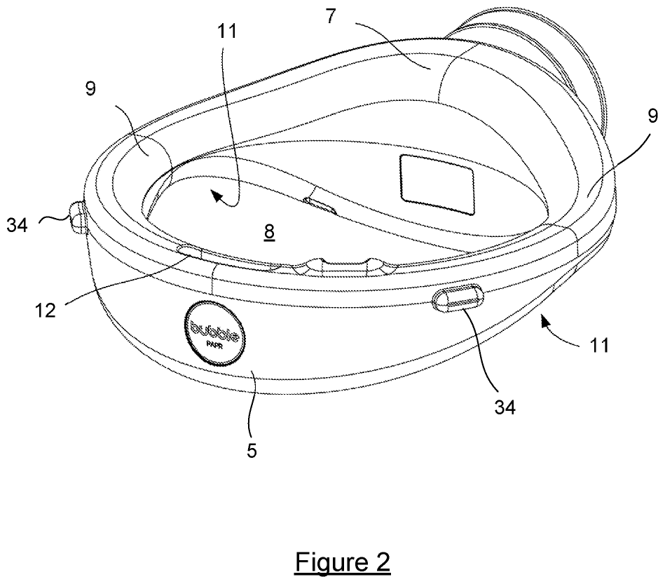

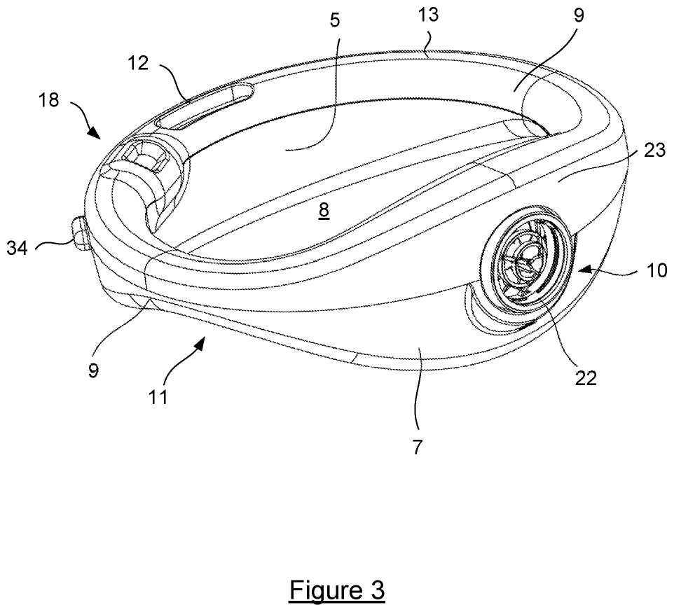

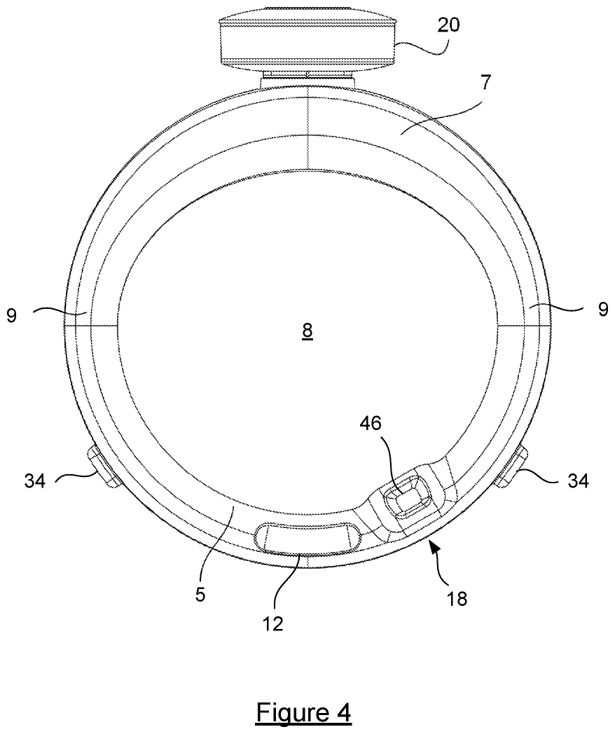

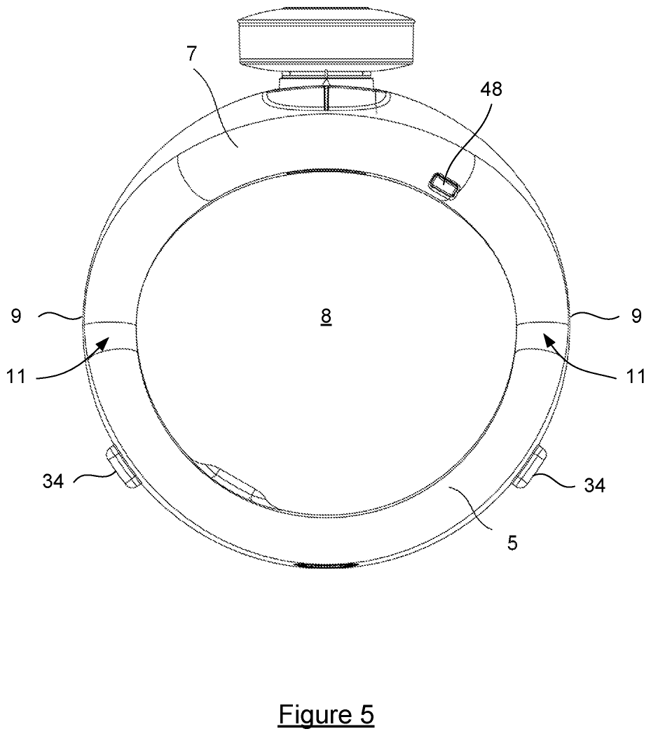

FIGS. 2 and 3 respectively shown front and rear perspective views of the yoke 4, and FIGS. 4 and 5 respectively show top and bottom plan views of the yoke 4. The yoke 4 defines a front portion 5, a rear portion 7 and side portions 9 relative to the position of the user's head. As shown most clearly in FIG. 2, the yoke 4 comprises a pair of shoulder rests 11 on an underside of the yoke 4. The shoulder rests 11 are generally curved so as to define a correspondingly shaped geometry to the user's shoulders. Put another way, the shoulder rests 11 each define part of a negative image of a generalised user shoulder so that the user's shoulders can be received by the shoulder rests 11. The shoulder rests 11 enable the yoke 4 to receive and rest securely upon the user's shoulder.

Although the yoke 4 is generally ring-shaped and/or collar-shaped, it will be appreciated that in alternative embodiments the yoke 4 may not define a complete ring. For example, the front portion 5 of the yoke 4 may be omitted such that the yoke 4 only runs over the shoulders and around the back of the user's head. It will be appreciated that, in general, the yoke may be any shape that is configured to be supported by the user's shoulders around the user's neck.

Preferably the yoke 4 is weighted to increase the frictional contact between the shoulder rests 11 and the user. In particular, weights may be positioned within the yoke 4 at the front portion 5, rear portion 7 and/or side portions 9. Preferably the yoke 4 is weighted in the front portion 5 to counterbalance the weight of the pump 16 and filter 20 (discussed below). Preferably, the overall weight of the yoke 4 and filter 20 is around 1 kg to provide adequate frictional contact with the user.

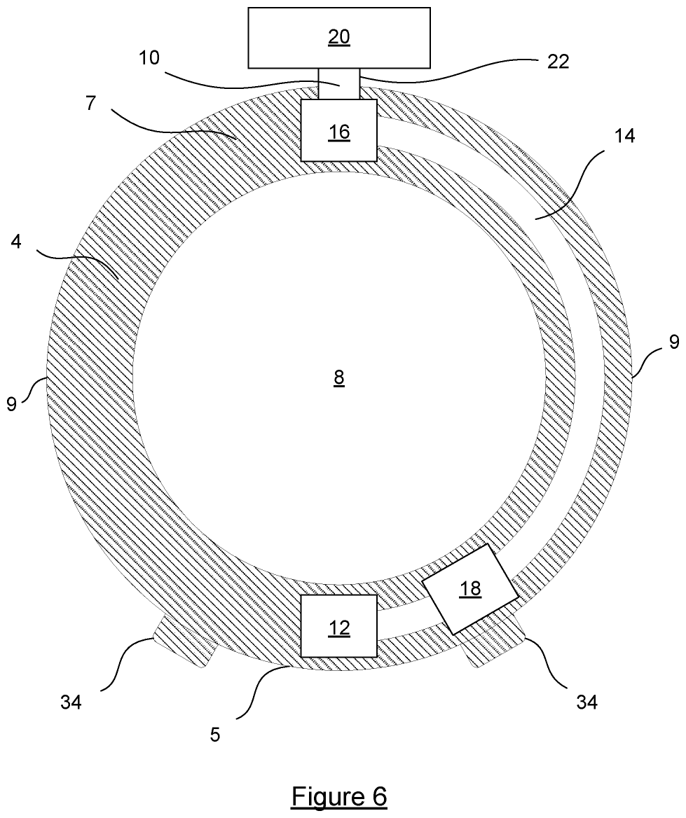

FIG. 6 shows a schematic cross-sectional view of an interior of the yoke 4. The yoke 4 comprises an air inlet 10 and an air outlet 12 connected via an air flow passage 14 contained within the interior of the yoke 4. The yoke 4 further comprises a pump 16 and a flowmeter 18 which are contained within the interior of the yoke 4 and disposed within the air flow passage 14. The PAPR 2 further comprises a filter 20 fluidly connected to the air inlet 10 via a spigot 22 which protrudes from the yoke 4. The pump 16 is electrically connected to a battery external to the yoke 4 by a cable (not shown). During use, the pump 16 draws air into the air flow passage 14 via the filter 20 and the air inlet 10. The filtered air is pumped through the flowrate meter 18 and into the interior of the hood 6 via the air outlet 12. Once contained within the interior of the hood 6, the filtered air can be inhaled by the user.

Although the yoke 4 comprises a single air flow passage 14, it will be appreciated that in alternative embodiments the yoke 4 may comprise more than one air flow passage 14. For example, the yoke 4 could comprise a second air flow passage 14 extending around the opposite side of the yoke 4 to the first air flow passage 14. When the yoke 4 comprises more than one air flow passage 14, this increases the cross-sectional area available for flow thus enabling a higher rate of flow delivery. Each airflow passage may share a common air inlet and/or a common air outlet or may define a separate air inlet and a separate air outlet. Furthermore, each airflow passage 14 may have a separate pump 16 and flowrate meter 18. In such embodiments, the second airflow passage may provide redundancy in the event that the first air flow passage is blocked.

### Filter

The spigot 22 and filter 20 are positioned at the rear portion 7 of the yoke 4. With reference to FIG. 3, the rear portion 7 of the yoke 4 defines a rearwardly facing outer surface 23 from which the spigot 22 extends. The spigot 22 defines the air inlet 10. Because the spigot 22 is defined by the rear portion 7 of the yoke 4, the filter 20 is positioned behind the user during use. As such, the filter 20 draws in air that is positioned on the opposite side of the user to the patient the user is treating. This helps to minimise the concentration of pathogens in the intake air and therefore reduces the burden on the filter 20. However, it will be appreciated that in alternative embodiments the air inlet 10, spigot 22 and/or filter 20 may be positioned at substantially any suitable part of the yoke 4, for example the front portion 5 or the side portions 9. The spigot is preferably coloured a contrasting colour to the yoke 4 and the filter 20 so that it is obvious when the filter 20 is not attached. However, in alternative embodiments an alternative means may be provided to alert the user to the presence or absence of the filter. For example, the presence of the filter may activate a safety switch which must be depressed in order to provide power to the pump 16. Additionally or alternatively, the yoke 4 may comprise suitable control electronics configured to detect the presence or absence of the filter and communicate this to the user via an indication means such as an LED, buzzer or the like.

The filter 20 is connectable to and separable from the spigot 22. Because the filter 20 is separable from the spigot 22, this enables the filter 20 to be easily replaced once it has reached the end of its service life. As shown in FIG. 1, the filter 20 is positioned externally to the hood 6. Because the filter 20 is external to the hood 6, the filter can be shaped so as to draw in air from a large surface area. In the present embodiment, the filter 20 is generally cylindrical and draws in air from a rearwardly facing circular aperture having a larger diameter than the air inlet 10. However, it will be appreciated that in alternative embodiments substantially any suitable filter geometry may be used. Furthermore, in some embodiments the filter 20 may not be external to the hood 6, and may be positioned inside the hood 6, and fluidly connected to the exterior of the hood 6 by a conduit. In yet further embodiments, the filter 20 may be contained within the yoke 4. In such embodiments, the yoke 4 may comprise a removable housing or the like configured to provide access to the filter 20 so that the filter can be removed and replaced.

The filter 20 is capable of removing harmful substances from the air so that the air delivered to the user is safe to breathe. The filter 20 may therefore be chosen in dependence upon the type of environment in which the PAPR 2 will be used. For example, if the PAPR 2 is to be used in an environment containing a high concentration of particulates, the filter 20 may be a particle filter. However, the PAPR 2 of the present invention is primarily intended for, although not limited to, use in medical environments and in particular for the treatment of patients having highly contagious diseases transmitted by airborne pathogens. As such, the filter 20 is preferably a pathogen filter capable of removing pathogens carried in airborne water droplets. In one embodiment, the filter 20 may be a TH3-P type filter or the like.

### Air Outlet

With reference to FIG. 3, the air outlet 12 is defined by a generally elongate slot of the front portion 5 of the yoke 4. Because the air outlet 12 is an elongate slot, the air outlet 12 is relatively large and therefore easy to clean. The air outlet 12 is positioned on an upper surface 13 of the yoke 4 and so that it is directly in front of the user's face during use. By positioning the air outlet 12 in front of the user's face this ensures filtered air is delivered close to the user's mouth and nose and minimises the formation of CO2 pockets in the vicinity of the user's nose and mouth. This further counteracts the build-up of water vapour on the inside of the hood 6 caused by the user's breath. Preferably, the air outlet 12 is oriented so that it is slightly angled towards the user's face to keep the user cool. Additionally, a sump is provided at the air outlet 12 to collect any fluids exhaled by the user (for example if the user coughs or sneezes).

### Pump

The pump 16 is a centrifugal pump driven by an electric motor. However, it will be appreciated that in alternative embodiments substantially any suitable pump type may be used, for example an axial pump, a mixed flow pump, a regenerative pump or the like. The pump 16 preferably has a power output of around 0.5 to 2 W so that the pump 16 is capable of drawing air through the filter 20 and into the interior of the hood 6. In yet further embodiments, substantially any suitable mechanism for causing air to flor through the air flow passage 14 may be used.

### Battery Pack

As discussed above, the pump 16 is powered by a battery. In some circumstances, batteries can produce gasses that may be harmful to the user. Preferably the battery is separate to the yoke 4 and stored outside of the hood 6 during use. This prevents any gases produced by the battery from being inhaled by the user. With reference to FIG. 5, the yoke 4 comprises an aperture 48 through which an electrical cable (not shown) is passed. The aperture 48 is positioned on an underside of the yoke 4 at the rear portion 7 of the yoke 4. The electrical connector is electrically connected to the pump 16 at one end and is configured to electrically connected to a battery pack (not shown) at an opposite end to supply electrical energy to the pump 16. The battery pack is carried in the user's pocket or may be worn on a belt fastened around the user. Because the electrical connector 48 is positioned at the rear portion 7 of the yoke 4, the electrical cable can be routed down the back of the user so that it does not impeded movement of the user.

Although the battery pack of the present embodiment is separate to and disposed outside of the yoke 4 and hood 6, in alternative embodiments the battery may be contained within the yoke 4. However, if the battery is to be positioned within the yoke 4, the yoke 4 is preferably provided with a containment structure configured to fluidly contain any gases produced by the battery. Additionally or alternatively, the yoke 4 may be provided with a vent connected to the environment external to the hood 6 to ensure that any gases produced by the battery are not inhaled by the user, and/or a battery type having a sufficiently low risk of gas emission may be used.

Aside from any control electronics contained within the battery, the PAPR 2 does not comprise any control circuitry. As such, as soon as the battery is connected to the electrical cable power is delivered to the pump 16 and air is drawn through the air flow passage 14. Because the PAPR 2 does not comprise electronic control circuitry, the electronics of the PAPR 2 are extremely simple and therefore the chance of electronic failure is minimised.

### Flowrate Meter

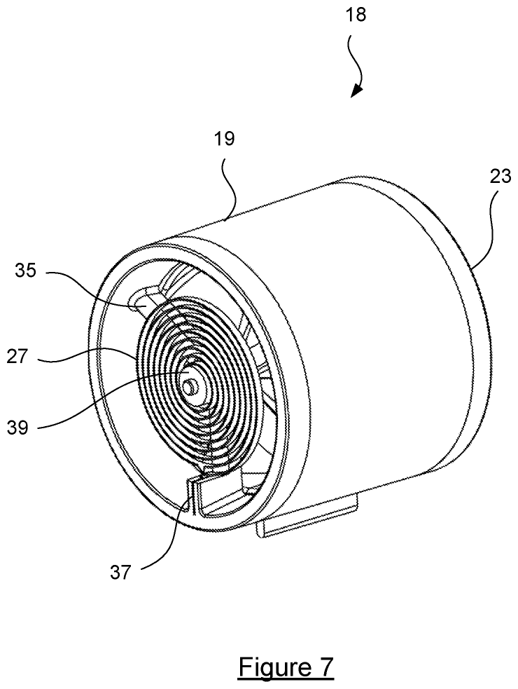

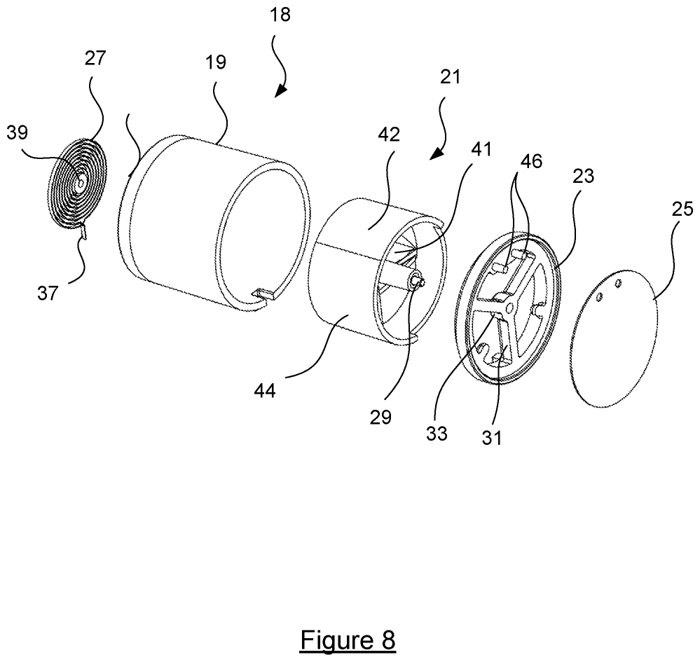

FIG. 7 shows the flowrate meter 18 in an assembled state and FIG. 8 shows the flowrate meter 18 in an exploded view. With reference to FIG. 8, the flowrate meter 18 comprises a housing 19, an indicator barrel 21, a support ring 23, a valve member 25 and a clock spring 27. The housing is 19 is cylindrically tubular and the indicator barrel 21 is correspondingly cylindrical. The housing 19 is sized to receive the indicator barrel 21 therein. The indicator barrel 21 comprises a central axle 29 aligned with the longitudinal central axis of the indicator barrel 21. The support ring 23 comprises inwardly extending spokes 31 supporting a central hub 33 configured to receive one end of the axle 29. With reference to FIG. 7, the housing 19 comprises a corresponding set of spokes 35 supporting a central hub (not shown) configured to receive the opposite end of the central axle 29. The housing 19 and the support ring 23 thereby support the indicator barrel 21 for rotation within the housing 19.

The clock spring 27 is a spiral shaped spring comprising a flange 37 positioned at the outside terminal end of the spiral and a hub 39 positioned at the inner terminal end of the spiral. The flange 37 of the clock spring 27 is connected to the housing 19 and the hub 39 of the clock spring 27 is connected to the central axle 29 of the indicator barrel 27. The indicator barrel 21 and the housing 19 are is generally hollow such that air can pass from one side of the flowrate meter 18 to the other. As such, the indicator barrel 21 and the housing 19 form part of the air flow passage 14. The indicator barrel 21 comprises a number of baffle elements 41 extending across the centre of the indicator barrel 21. The baffle elements 41 are inclined relative to the direction of flow through the indicator baffle 21 such that incident air causes the indicator barrel 21 to rotate about the central axle 29 against the action of the clock spring 27.

The exterior of the indicator barrel 21 defines two indicator sections 42, 44 which are painted in different colours, patterns or with different text. One of the indicator sections 42 corresponds to a safe operating state of the PAPR 2 whilst the other of the indicator sections corresponds to an unsafe operating state of the PAPR 2. For example, the safe operating state may be coloured green and the unsafe operating state may be coloured red. The housing 19 is transparent such that the indictor section 42, 44 can be seen through the housing 19 from the outside. It will be appreciated that in alternative embodiments substantially any suitable number of indicator sections may be provided. For example, a third indicator section may be provided corresponding to an unsafe operating condition of the PAPR 2 in which the user has not attached the filter and therefore the flow through the flowrate meter 18 is abnormally high. In further embodiments, the indicator barrel 21 may define a continuous indicator for example using a continuously variable colour gradient.

With reference to FIG. 4 the yoke 4 comprises a window 46 and the flowrate meter 18 is aligned with the window 46 such that the indicator barrel 21 can be seen through the window 46. The window 46 is positioned such that it is visible to the user during use. In particular, the flowrate meter 18 is positioned at the front portion 5 of the yoke 4 and as close to the air outlet 12 so that that it can be easily seen by the user.

The indicator sections 42, 44, baffle elements 41, and clock spring 27 are configured such that, during use, when air under the action of the pump 16 flows through the flowrate meter 18 at a rate corresponding to a safe rate of delivery for the user the indicator section 42, 44 corresponding to the safe operating state will be aligned with the window 46. Should the rate of air delivery through the airflow passage 14 drop for any reason (for example, because of a blockage, power depletion, or pump failure) the force exerted by the air on the baffle elements 41 will reduce and the indicator barrel 21 will rotate under the action of the clock spring 27 so that the indicator section 42, 44 corresponding to the unsafe operating state is aligned with the window 46. As such, the user can visually determine whether or not filtered air is being delivered to the interior of the hood 6.

The support ring 23 comprises a pair of protrusions which receive corresponding holes of the valve member 25. The protrusions 46 are heat staked so as to permanently attach the valve member 25 to the support ring 23. The protrusions 46 support the valve member 25 at one end. The valve member 25 is made from a deformable plastic material such that the valve member 25 is able to flap open and closed in response to air passing through the flowrate meter 18. The valve member 25 forms a one-way valve that permits flow to pass through the flowrate meter 18 from the air inlet 10 to the air outlet 12 but prevents flow in a reverse direction form the air outlet 12 to the air inlet 10. This protects the flowrate meter from backflow through the air flow passage 14 when the user sneezes or coughs, and provides protection for the flowrate meter when the yoke is being cleaned. Furthermore, in the event that the pump 16 fails or power to the pump 16 is lost, the valve member 25 will permit flow through the airflow passage 14 into the interior of the hood 6 whilst maintaining the pressure of the air within the hood 6.

Although the flowrate meter 18 uses a rotatable baffle element 41 to measure the amount of air flowing through the airflow passage 14, it will be appreciated that in alternative embodiments substantially any suitable baffle arrangement may be used. Furthermore, the flowmeter 18 does not include any electrical components, and therefore the flowmeter 18 can be relied upon even in the event of power failure or depletion. However, in alternative embodiments the flowrate meter may include electrical components such as for example an electrical flow meter and/or an electronic display device. Furthermore, although the indicator barrel 21 and indicator sections 42, 44 are positioned within the air flow passage 14, it will be appreciated that in alternative embodiments a visual indicator may be provided outside of the air flow passage 14, the visual indicator being controlled by a baffle element disposed within the air flow passage 14.

### Hood

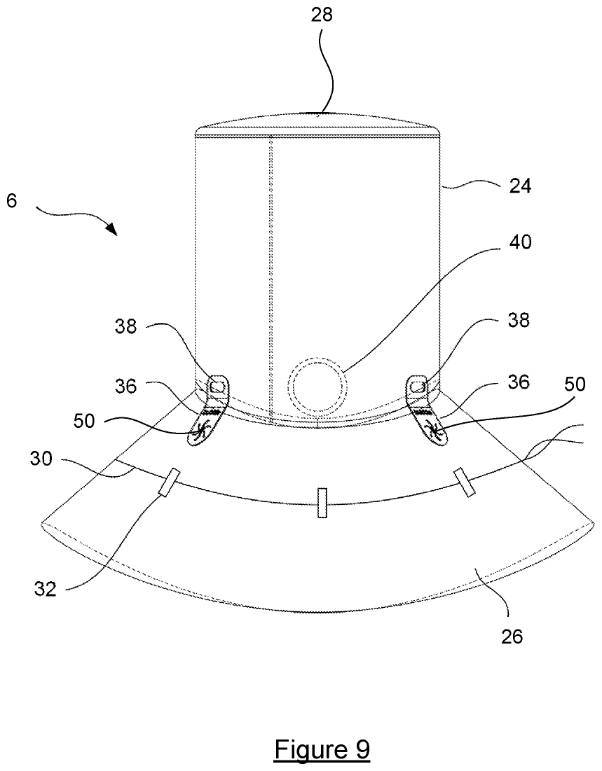

FIG. 9 shows a schematic view of the hood 6. The hood 6 comprises a head portion 24 and a poncho 26. The head portion 24 is generally cylindrical such that it is able to completely contain and surround the user's head. The poncho 26 is connected to the bottom of the head portion 24 and forms a skirt depending downwardly from the head portion 24. During use, the poncho 26 is gathered around the user's neck underneath the yoke 4 to create an approximate seal between the user's neck and the poncho 26. This prevents external air being carried into the interior of the hood 6.

The head portion 24 is preferably made from a transparent material so that the user is able to see through the head portion 24. In some embodiments the entire hood 6 may be transparent, or only the head portion 24 or a sub-section of the head portion 24 (i.e. a window of the head portion 24) may be transparent. The material of the head portion 24 is chosen so that the head portion is impermeable to fluids (in particular, airborne water droplets) as such fluids may contain dangerous pathogens. Suitable materials include plastic, rubber, glass etc. However, most preferably the head portion 24 is made from a transparent, flexible plastics material such as polyvinyl chloride (PVC). Such materials are generally lightweight and easy to manipulate, thus making the hood 6 comfortable to wear and easier for the user to don and doff.

The poncho 26 may be made from any suitable material and need not necessarily be made from the same material as the head portion 24 (although in some embodiments the head portion 24 and poncho 26 may in fact be made from the same material). In particular, there is no requirement for the poncho 26 to be transparent. Preferably, the poncho 26 is made from a flexible impermeable membrane, such as for example a plastic material such as PVC or a non-woven textile such as Dupont Tyvek or the like. When the poncho 26 is made from a flexible impermeable membrane, the poncho 26 is easier to handle by the user, easier to gather around the user's neck and more comfortable for the user during use. Even more preferably, the material of the poncho 26 is relatively thin and/or light so as to make the poncho 26 easier to gather and manipulate.

The hood 6 preferably further comprises a gathering mechanism in the form of a draw string 30. The draw string 30 may be separate to the poncho 26, or may be attached to the poncho in some fashion, for example using a number of fabric loops 32 sown onto the poncho 26. During use, the draw string 30 can be pulled to gather the poncho 26 around the user's neck. Use of the draw string 30 is generally easier than gathering the poncho 26 around the user's neck by hand. The draw string 30 is preferably positioned about halfway down the poncho 26. Although the gathering mechanism is embodied as a draw string 30, in alternative embodiments the gathering mechanism may be any suitable mechanism for gathering the poncho 26 around the user's neck. The gathering mechanism may comprise coupling members, for example “hard” couplings in the form of buckles, clips or the like, or “soft” couplings in the form of hook and loop fastening strips or the like. The gathering mechanism may comprise coupling members that are attached directly to the poncho 26 or that are provided separately and tied around the poncho 26 in the same manner as the drawstring 30. For example, the gathering mechanism may comprise a belt or strap comprising coupling members.

The hood 6 further comprises a one-way exhaust valve 28. The one-way exhaust valve 28 is configured to allow air contained within the head portion 24 to be exhausted from the interior of the head portion 24 to the external environment. In the present embodiment, the one-way exhaust valve 28 is a so-called “umbrella valve” comprising a deformable sealing disk configured to selectively vent air through a passage. In alternative embodiments, the one-way exhaust valve 28 may be a so-called “flap valve” comprising a pair of flexible membranes positioned in close proximity to one another. The membranes bear against one another when the air pressure on either side of the one-way valve 28 is equal, and will separate from one another to define a narrow vent opening when the pressure of the air inside the hood 6 is higher than the pressure of the surrounding environment. Accordingly, external air is prevented from entering the interior of the hood 6 from the outside, but air inside the hood 6 can be vented so as to avoid a build-up of CO2 within the hood from the user's breath. Because the one-way valve 28 is made from flexible membranes, is can be made from the same materials as the hood 6, so that it is integrally formed with the hood 6. However, it will be appreciated that in alternative embodiments substantially any suitable one-way valve may be used.

Preferably the one-way exhaust valve 28 is positioned at a location of the hood 6 where any exhausted gasses containing the user's breath will be directed away from nearby patients. As such, in the embodiment shown, the one-way exhaust valve 28 is positioned at the top of the head portion 24 and is aligned centrally relative to the user's head. However, in alternative embodiments the one-way exhaust valve may be positioned at the rear of the hood so that it behind the user's head and therefore facing away from any patients the user is treating. Nevertheless, in further embodiments the one-way exhaust valve 28 may be positioned at any substantially any suitable location of the hood 6. Although the hood 6 described above comprises a single one-way exhaust valve 28, it will be appreciated that in alternative embodiments substantially any suitable number of exhaust valves may be provided on the hood 6 and positioned at any suitable location.

The pump 16 and exhaust one-way valve 28 are configured so as to control the pressure of the air within the interior of the hood 6 to an acceptable level. In particular, the gauge pressure of the air within the hood 6 should be around 50 Pa. Preferably the material of the head portion 24 is chosen so that at the pressures above the material of the head portions is stretched out to avoid the presence of wrinkles and thereby maximise visibility for the user.

Preferably, the hood 6 is disposable and a new hood 6 is supplied for each use of the PAPR 2. However, in some embodiments the hood 6 may be reusable. In particular, the hood 6 may be made from durable materials that are able to withstand decontamination and sterilisation processes, for example under LIV light. Although the hood 6 described above is a single piece, in alternative embodiments the hood may be provided in two pieces. For example, the hood may comprise a reusable inner section that is permanently sealed to the yoke 4 and may further comprise a removable and disposable outer section that fits over the yoke 4.

With reference to FIG. 2, the yoke 4 comprises a pair of protrusions 34, alternatively referred to herein as “first engagement portions”, positioned at the front of the yoke 4. With reference to FIG. 9, the hood comprises a pair of tabs 36, each tab 36 defining a pocket 38, alternatively referred to herein as “second engagement portions”. The pockets 38 define recesses shaped to receive and grab the protrusions 34. The pockets 38 are indentations formed either integrally within the tabs 36 or as compliant films applied to the outer side of the tab 36 around a correspondingly shaped hole formed in the tab 36. During use, frictional interference between the protrusions 34 and the pockets 38 couples the hood 6 to the yoke 4 to prevent accidental separation of the hood 6 and the yoke 4. Additionally, the coupling between the protrusions 34 and the pockets 38 ensures that the hood 6 is oriented correctly relative to the yoke 4. The tabs 36 are preferably made from a stiff plastics material bonded to the head portion 28 of the hood 6 via any suitable means (for example, via adhesive or ultrasonic welding). The pockets 38 (either as part of the body of the tabs 36 or as compliant films) cover the protrusions 34 so as to protect the protrusions from contamination.

Although in the described embodiment the yoke 4 comprises protrusions 34 and received within pockets 38 of the hood 6, it will be appreciated that in alternative embodiments the yoke 4 may define an engagement portion having any suitable geometry for engagement with a corresponding engagement portion of the hood 6. For example, the hood 6 may comprise one or more protrusions for receipt within a corresponding recess of the yoke 4. Further still, the engagement portions may comprise notches, channels, ribs, holes, lips, sliding connectors, hook and loop connectors, press studs, magnets, electromagnets, latches or generally any other suitable means or combinations thereof for securing the hood 6 to the yoke 4 and vice versa. Furthermore, although the yoke 4 and hood 6 comprises two pairs of mating engagement portions, it will be appreciated that in alternative embodiments substantially any number of pairs of mating engagement portions may be provided.

The hood 6 further comprises an aperture 40 configured to receive the spigot 22 of the yoke 4. The aperture 40 is sized to fit as closely as possible around the spigot 22. During use, the pressure of the air inside the hood 6 will be slightly higher than the pressure of the atmosphere due to the action of the pump 16. Leakage is therefore only likely to occur from the interior of the hood 6 to exterior of the hood 6 (and not from the exterior of the hood 6 to the interior of the hood 6). As such, potentially harmful pathogens external to the hood 6 will not be able to enter the hood 6 via the aperture Nevertheless, in alternative embodiments a sealing member may additionally be provided between the hood 6 and the yoke 4 surrounding the aperture 40 and the spigot 22.

In the embodiment shown, spigot 22 extends through the aperture such that the filter 20 is attached to spigot 22 on an exterior side of the hood 6. That is to say, the filter 20 is positioned outside the hood 6. In such configurations, the filter 20 can only be attached to the spigot 22 once the hood 6 has been mounted to the yoke 4. However, in alternative embodiments the hood 6 may comprise a split running from a base of the aperture 40 to the bottom of the poncho 26, and additionally the aperture 40 may define comprise a side opening such that the spigot 22 can be received within the aperture in a direction generally normal to the longitudinal axis of the spigot 22 (i.e. laterally). In such embodiments, the filter 20 can be attached to the yoke 4 before the hood 6 is present. When the hood 6 is subsequently mounted to the yoke 4, the split parts of the poncho 26 can be passed either side of the spigot 22 and the spigot 22 can enter the aperture from the side via the side opening. The split parts of the poncho 26 may subsequently be fastened together, for example using a zip fastener or the like. In such embodiments, the donning and doffing procedure may be simpler and faster due to the fact that the filter 20 does not need to be removed from the yoke 4. Additionally, this reduces the risk that the user forgets to attach the filter 20.

In a further alternative, the split need not run all the way to the bottom of the poncho 26, and instead may only extend a portion of the way to the bottom of the poncho 26. In such arrangements, the filter 20 can be passed through the split in the longitudinal direction of the spigot 22, and then moved laterally so that the aperture 40 is correctly seated around the spigot 22 via the side opening. In yet further embodiments, the split may comprise perforations running from the base of the aperture to the bottom of the poncho 26 and the user may be able to tear the poncho 26 along the perforations by a desired amount to form a split in accordance with either of the embodiments above and subsequently remove the hood 6 from the yoke 4 by passing the filter 20 through the split. The use of perforations allows the user remove the hood 6 easily, leaving the filter 20 in place, whilst reducing the risk of contamination to the user or of the yoke 4. In some embodiments, when donning the hood 6 the spigot 22 may be received through the aperture 40 along the longitudinal direction of the spigot 22 without tearing the perforations and the filter 20 may be fitted afterwards. When it is desired to remove the hood, the perforations can be torn to create a split, thus enabling the hood 6 to be removed whilst leaving the filter 20 in place.

Additionally or alternatively, the hood 6 may be sized to fit around both the yoke 4 and the filter 20 when the filter is mounted to the spigot 22. That is to say, the hood 6 may be sized so that during use the filter 20 is positioned within the interior of the hood 6. In such embodiments, the aperture 40 may be sized so that it is substantially the same diameter as the air-intake face of the filter 20. Furthermore, the aperture 40 may comprise a circumferentially extending interior lip that is configured to couple the aperture 40 of the hood 6 to the filter 20. Such a lip may be made from a resiliently deformable material, such as a plastic, and may be configured so that the filter 20 is received by the lip and coupled to the lip under elastic tension. Again, in such embodiments the filter 20 does not need to be removed from the yoke 4. Therefore donning and doffing is simpler and faster, and the risk that the user forgets to attach the filter 20 is reduced. Furthermore, because the filter 20 is positioned within the interior of the hood 6, the filter 20 is generally protected from contamination during use.

In some embodiments the aperture 40 and the circumferentially extending lip may comprise a side opening, and the hood 6 may comprise perforations and/or a split extending from the side opening of the aperture 40. The perforations and/or split can be parted to provide additional space for the hood 6 to fit over the filter 20 when the hood 6 is being attached or removed from the yoke 4. Put another way, the split and/or perforations may provide additional compliance to the hood 6 to enable to hood 6 to be passed over the geometry of the filter 20, which will protrude from the yoke 4. This enables the hood 6 to be fitted and removed from the yoke 4 more easily.

The tabs 36 are positioned on the exterior side of the hood 6 and comprise gripping portions 50. The gripping portions 50 are configured to receive a portion of an apron, such as a surgical apron (not shown). Such surgical aprons are typically made from a sheet of flexible plastics material. When the apron is inserted in to the gripping portions 50, friction engagement between the gripping portions 50 and the apron holds the apron securely in position. In the embodiment shown, the gripping portions 50 are generally star-shaped apertures in the tabs 36. The gripping portions 50 comprise a number of cantilevered arms which are configured to flex so that the apron can be gripped therebetween. Preferably, the material of the tabs 36 is a flexible plastics material so as to permit the arms of the gripping portions 50 to flex. It will be appreciated that in alternative embodiments the gripping portions 50 may have any suitable construction configured to grip a portion of an apron. For example, the gripping portions 50 may comprise reciprocating jaws, teeth, clamps, hook and loop fasteners, press studs, magnetic connectors or the like.

Preferably, the gripping portions 50 are positioned on the left and right hand sides of the hood relative to the user's face so that the apron is supported across the user's front. Although the gripping portions 50 above are described as forming part of the tabs 36, in alternative embodiments the gripping portions may be provided and positioned separately to the tabs 36.

### Method of Use

Use of the PAPR 2 for medical applications will now be described. Before use, the yoke 4 is preferably cleaned and decontaminated to ensure that any harmful pathogens on the surfaces of the yoke 4 are killed. Cleaning may take placed, for example, by using a sterilising solution (e.g. alcohol, detergent or chlorhexidine-based wipes). If the hood 6 is of the disposable variety, the hood 6 is preferably provided in a sterile state (for example, contained within protective packaging).

An example donning procedure is described below. Starting from the state in which the user is wearing base layer clothing suitable for the environment and tasks to be undertaken (for example “scrubs”), the user collects PAPR 2 from a storage facility and visually inspects the PAPR 2. The user washes their hands and puts on a first set of (inner) gloves. The user then places the yoke 4 within the hood 6. The spigot 22 is passed through the aperture 40 of the hood 6 and the filter 20 is attached to the spigot 22. The protrusions 34 are then received within the pockets 38 of the tabs 36 to secure the hood 6 to the yoke 4. The user takes the battery and stores it in their pockets or wears t on a belt around their body. The battery is then connected to the pump 16 via the electrical cable. As soon as the battery is connected, power is delivered to the pump 16 and air begins to flow through the air flow passage 14. Next, the user inserts their head through the central aperture 8. Subsequently the user pulls the draw string 30 (or gathers the poncho 26 using another form of gathering mechanism) to tuck the poncho 26 underneath the yoke 4. The user may tuck the bottom part of the poncho into their scrubs or may rest the bottom part of the poncho on top of their scrubs. The user then rests the yoke 4 on their shoulders using the shoulder rests 11 so that the poncho 26 is held in position between the yoke 4 and the user's body.

Subsequently, the user dons a protective gown in the usual manner. The neck portion of the surgical gown can be received underneath the yoke 4. If the poncho has been tucked into the user's scrubs, the surgical gown can be received underneath the yoke 4 between the upper part of the poncho 26 and the user's scrubs. If the poncho 26 has not been tucked into the user's scrubs, the surgical gown can be received between the folds of the poncho 26. In either configuration, the weight of the yoke 4 rests upon at least part of the surgical gown. However, in alternative embodiments, the surgical gown may be simply be fitted around the outside of the yoke 4.

Next, the user may don an outer apron, if required, by pressing a portion of the apron into each of the gripping portions 50. The apron may additionally be tied around the user's waist using straps forming part of the apron. Finally, the user dons a second (outer) set of gloves over the first set of gloves, if required. The apron and the second set of gloves can be disposed of and changed for each different patient treated by the user.

An example doffing procedure is described below. To doff the PAPR 2, the user moves away from any potentially hazardous area and to a suitable location for doffing the PAPR 2 (a doffing location may be specifically designated for this purpose). The user first removes the apron and the second (outer) set of gloves if present. The user then cleans the first (inner) set of gloves and removes the protective gown. The draw string 30 (or another form of gathering mechanism) is then untied and the poncho 26 is ungathered and untucked from the user's scrubs. The pockets 38 of the tabs 36 are uncoupled from the protrusions 34 of the yoke 4 and, in some embodiments, the filter 20 may be removed. Next, the user removes the hood 6 from the yoke 4 in a forward motion, removing the hood 6 from their head whilst ensuring their head does not contact the exterior part of the hood 6. In embodiments where the hood 6 comprises a split or perforations, the hood 6 may be removed whilst the filter 20 remains in place (e.g. by tearing the perforations and passing the filter 20 through the split). The hood 6 may be balled up so that the clean interior of the hood 6 is facing outmost. The hood 6 is then disposed of simultaneously with the first (inner) set of gloves. The yoke 4 is then removed from the user's head and the battery is disconnected. The yoke 4 is then decontaminated with sterilising solution and placed back into storage.

It is recognised that infection control policies and practices may vary between locations, organisations and over time such that the donning and doffing procedure described above may be subject to variations and modifications. For example, in some embodiments the yoke 4 and the hood 6 may be removed from the user's head simultaneously. Furthermore, as explained above, in some embodiments of the PAPR 2 the filter 20 may not need to be removed.

1. A powered air purifying respirator comprising:
a yoke defining an air inlet and an air outlet fluidly connected via an air flow passage; and
a pump disposed within an interior of the yoke and configured to pump air from the air inlet to the air outlet via the air flow passage;
wherein the yoke is shaped to fit around a user's neck and be supported by the user's shoulders.

2. The powered air purifying respirator according to claim 1, wherein the yoke defines a pair of shoulder rests configured to rest upon the user's shoulders.

3. The powered air purifying respirator according to claim 1, wherein the yoke is generally ring-shaped and defines a central aperture configured to receive the user's head.

4. The powered air purifying respirator according to claim 1, wherein the yoke comprises a front portion and a rear portion relative to the user's head, and wherein the air inlet is defined by the rear portion of the yoke and wherein the air outlet is defined by the front portion of the yoke, optionally wherein the rear portion of the yoke defines a rearwardly facing surface in relation to the user's head, and wherein the air inlet is positioned on the rearwardly facing surface.

5. (canceled)

6. The powered air purifying respirator according to claim 4 or 5, wherein the front portion of the yoke defines an upper surface, and wherein the air outlet is positioned on the upper surface of the yoke such that during use air exiting the yoke via the air outlet is directed towards the user's face.

7. The powered air purifying respirator according to claim 1, further comprising a filter in gas flow communication with the air inlet, optionally wherein the filter is removable.

8. (canceled)

9. The powered air purifying respirator according to claim 7, wherein the filter is connected to the air inlet on an exterior of the yoke.

10. The powered air purifying respirator according to claim 1, wherein the yoke comprises an outwardly extending spigot defining the air inlet, the outwardly extending spigot being configured for engagement with a filter.

11. The powered air purifying respirator according to claim 1, further comprising a hood configured to receive the yoke and the user's head therein, optionally wherein the hood surrounds an outer periphery of the yoke during use.

12. (canceled)

13. The powered air purifying respirator according to claim 11, wherein the hood comprises an aperture configured to receive a spigot of the yoke therethrough; and/or wherein the hood comprises an aperture configured to permit gas flow communication between a filter and an environment external to the hood; and/or
wherein the hood comprises a split or a line of perforations extending radially outwards from the aperture.

14.-16. (canceled)

17. The powered air purifying respirator according to claim 11 any of claims 11 to 16, wherein the hood comprises a head portion configured to be positioned over the user's head and a poncho configured to be tucked under the yoke between the yoke and the user's body, optionally wherein the head portion is generally cylindrical.

18. (canceled)

19. The powered air purifying respirator according to claim 17, wherein the hood comprises a gathering mechanism configured to gather the poncho around the user's neck and/or the head portion comprises a transparent portion and/or the head portion is made from a gas-impermeable material and/or the poncho comprises a flexible impermeable membrane and/or the hood comprises a one-way exhaust valve configured to vent air from an interior side of the hood to an exterior side of the hood, and optionally wherein the one-way exhaust valve is positioned at the top of the hood.

20.-24. (canceled)

25. The powered air purifying respirator according to claim 11, wherein the yoke comprises a first engagement portion, and wherein the hood comprises a second engagement portion configured to engage the first engagement portion so as to attach the hood to the yoke.

26. (canceled)

27. The powered air purifying respirator according to claim 11, wherein the hood comprises a gripping portion configured to engage an apron, optionally wherein the gripping portion comprises an aperture configured to receive and frictionally engage a portion of the apron, optionally wherein the hood comprises an outwardly extending tab defining the gripping portion.

28. (canceled)

29. (canceled)

30. The powered air purifying respirator according to claim 1, further comprising a flowrate meter configured to measure a flowrate of air passing through the air flow passage.

31. The powered air purifying respirator according to claim 30, wherein the flowrate meter comprises a baffle disposed within the air flow passage, the baffle being configured to move in response to incident air flowing through the air flow passage, optionally wherein the flowrate meter comprises a spring configured to urge the baffle towards a position indicative of low flow through the air flow passage.

32. (canceled)

33. The powered air purifying respirator according to claim 30, wherein the flowrate meter comprises an indicator configured to display an indication of the flowrate of the air passing through the air flow passage to a user, optionally wherein the indicator is positioned at a front portion of the yoke.

34. (canceled)

35. The powered air purifying respirator according to claim 30, further comprising:
a one-way valve positioned downstream of the flowrate meter, the one-way valve being configured to permit flow from the flowrate meter to the air outlet and being configured to prevent flow from the air outlet to the flowrate meter.

36. A hood for a powered air purifying respirator, the hood comprising:
a head portion configured to receive a user's head, and
a one-way exhaust valve configured to vent air from an internal environment of the hood to an environment external to the hood;
wherein the hood is configured to receive a yoke of a powered air purifying respirator, optionally further comprising an engagement portion configured engage a corresponding formation of the yoke of the powered air purifying respirator to attach the hood to the yoke.

37. (canceled)

38. The hood according to claim 36, further comprising a poncho configured to be tucked underneath the yoke of the powered air purifying respirator between the yoke and the user's body, optionally further comprising a gathering mechanism configured to gather the poncho around the user's neck.

39-49. (canceled)
